(19) United States
(12) Patent Application Publication
(10) Pub. No.: US 2009/0268096 A1
(43) Pub. Date: Oct. 29, 2009

(54) VIDEO PROCESSING METHOD FOR DETERMINING TARGET MOTION VECTOR ACCORDING TO CHROMINANCE DATA AND FILM MODE DETECTION METHOD ACCORDING TO CHROMINANCE DATA

(76) Inventors: Siou-Shen Lin, Taipei County (TW); Te-Hao Chang, Taipei City (TW); Chin-Chuan Liang, Taichung City (TW)

Correspondence Address: NORTH AMERICA INTELLECTUAL PROPERTY CORPORATION, P.O. BOX 506, MERRIFIELD, VA, 22116, US

(21) Appl. No.: 12/111,195

(22) Filed: Apr. 28, 2008

(51) Int. Cl. H04N 9/64; H04N 5/14

(52) U.S. Cl. 348/699; 348/702; 348/E09.037

(57) ABSTRACT

A video processing method for determining a target motion vector includes generating a plurality of candidate temporal matching differences according to data of different color components in a specific color system and determining a vector associated with a minimum temporal matching difference from the candidate temporal matching differences as the target motion vector. A film mode detection method includes generating a plurality of candidate frame differences from a plurality of received frames according to data of different color components in a specific color system and performing film mode detection according to the candidate frame differences.

### BACKGROUND

The present invention relates to at least a video processing scheme, and more particularly, to video processing methods for determining a target motion vector according to chrominance data of pixels in a specific color system and to film mode detection methods for performing film mode detection according to chrominance data of received frames.

Generally speaking, a motion estimator applied to video coding, such as MPEG-2 or H.264 video coding, performs motion estimation according to luminance data of pixels within multiple frames for generating a group of motion vectors, and the motion vectors are used for reference when encoding the luminance data. Usually, in order to diminish computation costs, the above-mentioned motion vectors are also directly taken as reference when encoding chrominance data of the pixels. This may not cause serious problems for video coding. However, if the motion estimator described above is directly applied to other applications, (i.e., tracking or frame rate conversion), there is a great possibility that some errors will be introduced. This is because, for estimating actual motion of image object(s), only referring to motion vectors that are generated by the motion estimator according to luminance data of pixels is not enough. More particularly, manufacturers may produce a certain video pattern in which luminance data of pixels are similar or almost identical while chrominance data of the pixels are different. In this situation, if only the luminance data is referenced to determine motion vectors of image blocks within the video pattern, the determined motion vectors would be almost the same due to the similar luminance data. Performing the frame rate conversion according to the determined motion vectors will therefore cause some errors. For instance, a video pattern originally includes some image content, and this image content indicates that one person is wearing a red coat with a gray building in the background in this video pattern. Perceptibly, chrominance data of pixels of the red coat is quite different from that of the gray building. If luminance data of pixels of both the red coat and the gray building are similar, then only referencing the luminance data to perform motion estimation will cause the motion vectors determined by this motion estimation to be quite similar with each other. These nearly-identical motion vectors indicate that in the image content the red coat and gray building should be regarded as an image object having the same motion, but the gray building is actually usually still and the person wearing the red coat may be moving. Therefore, if the red coat and gray building are considered as an image object having the same motion, then through the frame rate conversion colors of the red coat and gray building in Interpolated frames may be mixed together even if this frame rate conversion is operating correctly. Thus, it is very important to solve the problems caused by directly referring to the chrominance data of the above-mentioned pixels to perform motion estimation.

One of the prior art skills is to generate a set of target motion vectors by referencing the luminance data and another set of target motion vectors by referencing the chrominance data. The different sets of target motion vectors are respectively applied to generate interpolated frames when performing the frame rate conversion. Obviously, some errors may be usually introduced to the generated interpolated frames when a certain image block has two conflicting target motion vectors that come from the respective different sets of the target motion vectors. Additionally, generating two sets of target motion vectors also means that double storage space is required for storing all these motion vectors.

In addition, for film mode detection, a film mode detection device usually decides whether a sequence of frames consists of video frames, film frames, or both by directly referring to luminance data of received frames. If the received frames include both video frames and film frames and luminance data of the video frames are identical to that of the film frames, the film mode detection device could make an erroneous decision by determining the original video frames to be film frames or the original film frames to be video frames. This is a serious problem, and in order to solve this problem, a conventional film mode detection technique provides a scheme for generating two sets of candidate frame differences by referencing the luminance data and the chrominance data separately. The conventional film mode detection technique, however, faces other problems, such as the different sets of candidate frame differences being conflicting and doubling the storage space required for storing all these candidate frame differences.

### SUMMARY

Therefore an objective of the present invention is to provide a video processing method and related apparatus for determining a target motion vector according to chrominance data of pixels in a specific color system. Another objective of the present invention is to provide a film mode detection method and related apparatus, which performs film mode detection according to chrominance data of received frames.

According to a first embodiment of the present invention, a video processing method for determining a target motion vector is disclosed. The video processing method comprises generating a plurality of candidate temporal matching differences according to data of different color components in a specific color system and determining a vector associated with a minimum temporal matching difference from the candidate temporal matching differences as the target motion vector.

According to the first embodiment of the present invention, a video processing method for determining a target motion vector is further disclosed. The video processing method comprises generating a plurality of candidate temporal matching differences according to chrominance data and determining a vector associated with a minimum temporal matching difference from the candidate temporal matching differences as the target motion vector.

According to a second embodiment of the present invention, a film mode detection method is disclosed. The film mode detection method comprises generating a plurality of candidate frame differences from a plurality of received frames according to data of different color components in a specific color system and performing a film mode detection according to the candidate frame differences.

According to the second embodiment of the present invention, a film mode detection method is further disclosed. The film mode detection method comprises generating a plurality of candidate frame differences from a plurality of received frames according to chrominance data and performing film mode detection according to the candidate frame differences.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a video processing apparatus according to a first embodiment of the present invention.

FIG. 2 is a block diagram of a film mode detection apparatus according to a second embodiment of the present invention.

FIG. 3 is a flowchart of the video processing apparatus shown in FIG. 1.

FIG. 4 is a flowchart of the film mode detection apparatus shown in FIG. 2.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

In this description, a video processing apparatus and related method are first provided. This video processing scheme is used for determining a target motion vector according to data of different color components in a specific color system or according to only chrominance data. Second, a film mode detection apparatus and related method, which perform film mode detection according to data of different color components in a specific color system or according to only chrominance data, are disclosed. Both objectives of the video processing apparatus and film mode detection apparatus are to refer to the data of the different color components in the specific color system or to refer only to the chrominance data, for achieving the desired video processing operation and detection, respectively.

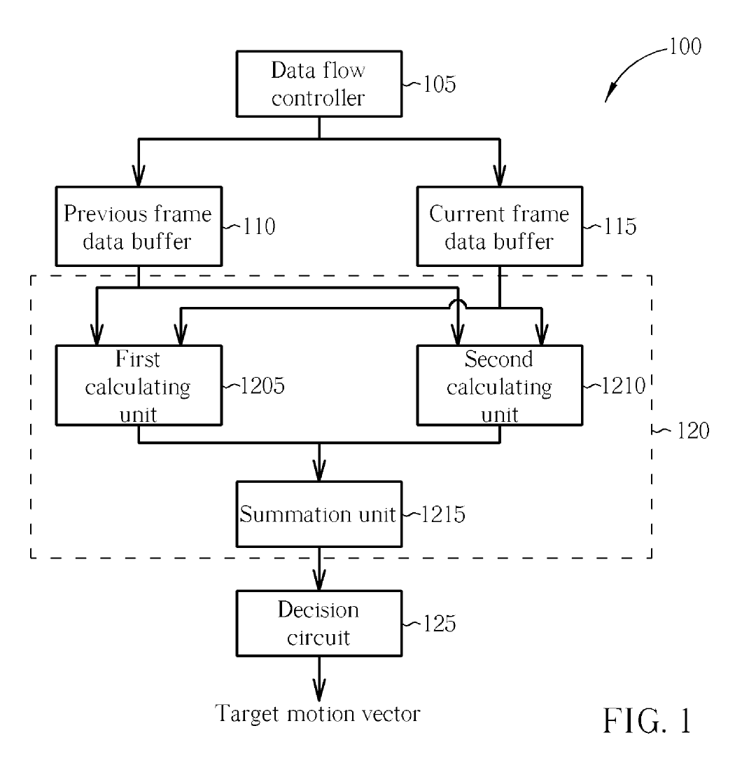

Please refer to FIG. 1. FIG. 1 is a block diagram of a video processing apparatus 100 according to a first embodiment of the present invention. As shown in FIG. 1, the video processing apparatus 100 is utilized for determining a target motion vector. The video processing apparatus 100 comprises a data flow controller 105, a previous frame data buffer 110, a current frame data buffer 115, a calculating circuit 120, and a decision circuit 125. The data flow controller 105 controls the previous and current frame data buffers 110 and 115 to output previous and current frame data, respectively. The calculating circuit 120 is used for generating a plurality of candidate temporal matching differences according to data of different color components of the previous and current frame data in a specific color system, and the decision circuit 125 is utilized for determining a vector associated with a minimum temporal matching difference among the candidate temporal matching differences as the target motion vector.

Specifically, data of the different color components comprises data of a first color component (e.g., luminance data) and data of a second color component (e.g., chrominance data). The calculating circuit 120 includes a first calculating unit 1205, a second calculating unit 1210, and a summation unit 1215. The first calculating unit 1205 generates a plurality of first temporal matching differences according to the data of the first color component (i.e., the luminance data), and the second calculating unit 1210 generates a plurality of second temporal matching differences according to the data of the second color component (i.e., the chrominance data). The summation unit 1215 then respectively combines the first and second temporal matching differences to derive the candidate temporal matching differences that are outputted to the decision circuit 125. In this embodiment, the summation unit 1215 calculates summations of the first and second temporal matching differences to generate the candidate temporal matching differences, respectively. As mentioned above, an objective of the calculating circuit 120 is to consider both the luminance data and the chrominance data for generating the candidate temporal matching differences, which are combinations of the first and second temporal matching differences, respectively. The decision circuit 125 then determines the vector associated with the minimum difference among the candidate temporal matching differences as the target motion vector. By doing this, for frame rate conversion, the target motion vector generated by the decision circuit 125 becomes accurate, i.e., this target motion vector can correctly indicate actual motion of a current image block. Therefore, the target motion vector can be utilized for performing frame interpolation without introducing errors. Compared with the prior art, since the decision circuit 125 in this embodiment only generates one set of target motion vectors, doubling the storage space is not required.

In implementation, for example, even though a motion vector V₁ corresponds to a minimum difference among the first temporal matching differences outputted by the first calculating unit 1205, this motion vector V₁ may be not selected as a target motion vector used for frame interpolation. This is because the motion vector V₁ may not correspond to a minimum candidate temporal matching difference. That is, in this situation, another motion vector V₂ associated with the minimum candidate temporal matching will be selected as the target motion vector, where the motion vector V₂ can correctly indicate actual motion of an image object. From the above-mentioned description, it is obvious that this embodiment considers temporal matching differences based on both the luminance and chrominance data to determine the target motion vector described above. Of course, in another example, the summation unit 1215 can also perform other mathematical operations instead of directly summing up the first and second temporal matching differences, respectively, such as taking different weightings upon the first and second temporal matching differences to generate the candidate temporal matching differences. The different weightings can be adaptively adjusted according to design requirements; this obeys the spirit of the present invention. Moreover, in this embodiment, each above-mentioned temporal matching difference (also referred to as “block matching cost”) is meant to a sum of absolute pixel differences (SAD); this is not intended to be a limitation of the present invention, however.

Furthermore, the first calculating unit 1205 can be designed to be an optional element, and is disabled in another embodiment. In other words, under this condition, the calculating circuit 120 only refers to the chrominance data of pixels to generate the candidate temporal matching differences into the decision circuit 125. This modification also falls within the scope of the present invention.

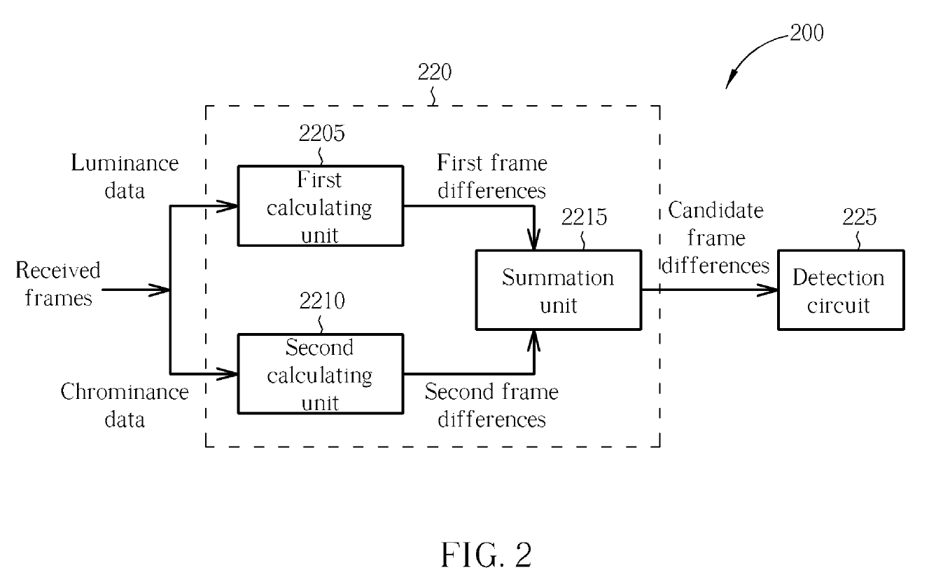

Please refer to FIG. 2. FIG. 2 is a block diagram of a film mode detection apparatus 200 according to a second embodiment of the present invention. As shown in FIG. 2, the film mode detection apparatus 200 comprises a calculating circuit 220 and a detection circuit 225. The calculating circuit 220 generates a plurality of candidate frame differences from a plurality of received frames according to data of different color components in a specific color system, where the data of the different color components comes from the received frames and includes luminance data and chrominance data. In this embodiment, luminance is a first color component in the specific color system while chrominance is a second color component in the specific color system. The detection circuit 225 then performs film mode detection according to the candidate frame differences, to identify each received frame as a video frame or a film frame.

The calculating circuit 220 comprises a first calculating unit 2205, a second calculating unit 2210, and a summation unit 2215. The first calculating unit 2205 generates a plurality of first frame differences according to data of the first color component (i.e., the luminance data), and the second calculating unit 2210 generates a plurality of second frame differences according to data of the second color component (i.e., the chrominance data). The summation unit 2215 then combines the first frame differences and the second frame differences to derive the candidate frame differences, respectively. In this embodiment, the summation unit 2215 calculates summations of the first and second frame differences to generate the candidate frame differences, respectively. As described above, an objective of the calculating circuit 220 is to consider both the luminance data and the chrominance data coming from the received frames to generate the candidate frame differences, which are combinations of the first and second frames differences, respectively. Next, the detection circuit 225 can perform the film mode detection according to the candidate frame differences, to correctly identify each received frame as a video frame or a film frame. Compared with the conventional film mode detection technique, in this embodiment, double storage space is not required.

Additionally, the first calculating unit 2205 can be designed to be an optional element and is disabled in another embodiment. That is, under this condition, the calculating circuit 220 only refers to the chrominance data coming from the received frames to generate the candidate frame differences to the detection circuit 225. This modification also falls within the scope of the present invention.

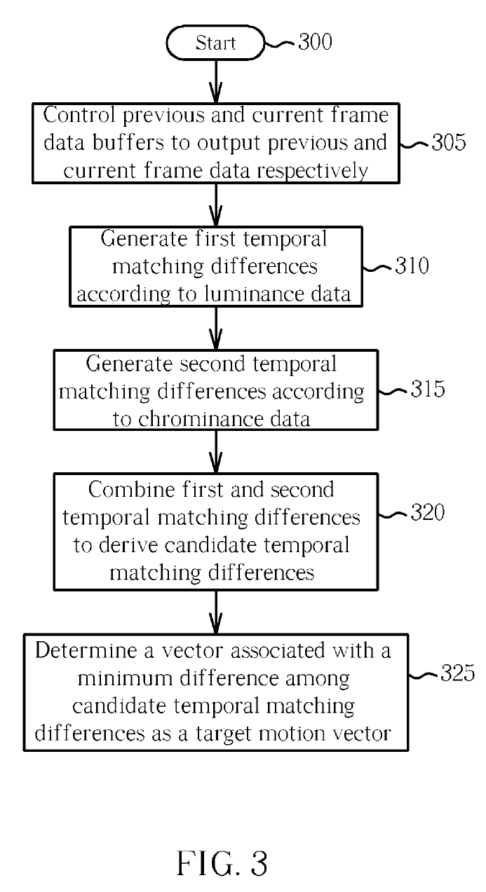

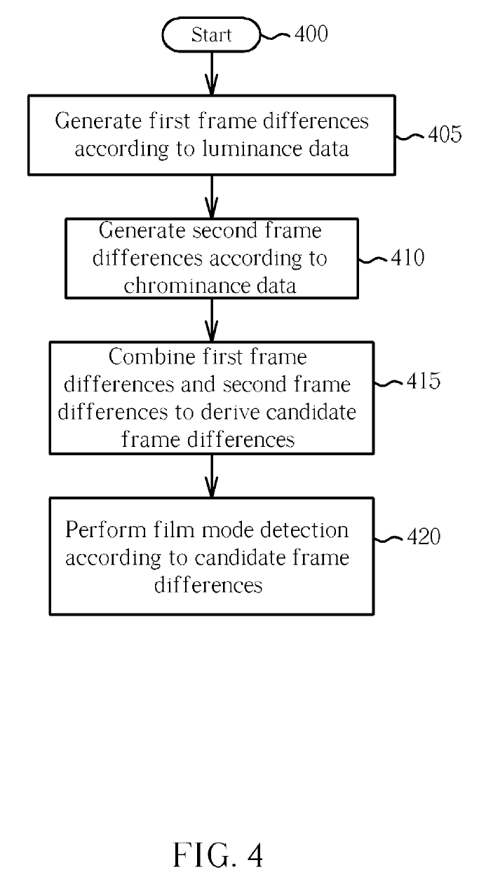

Finally, in order to describe the spirit of the present invention clearly, related flowcharts corresponding to the first embodiment of FIG. 1 and the second embodiment of FIG. 2 are illustrated in FIG. 3 and FIG. 4, respectively. FIG. 3 is a flowchart of the video processing apparatus 100 shown in FIG. 1; detailed steps of this flowchart are shown in the following:
Step 300: Start;
Step 305: Control the previous and current frame data buffers 110 and 115 to output previous and current frame data respectively;
Step 310: Generate the first temporal matching differences according to the data of the first color component (i.e., the luminance data);
Step 315: Generate the second temporal matching differences according to the data of the second color component (i.e., the chrominance data);
Step 320: Combine the first and second temporal matching differences to derive the candidate temporal matching differences; and
Step 325: Determine the vector associated with the minimum difference among the candidate temporal matching differences as the target motion vector.

FIG. 4 is a flowchart of the film mode detection apparatus 200 shown in FIG. 2; detailed steps of this flowchart are shown in the following:
Step 400: Start;
Step 405: Generate the first frame differences according to the data of the first color component (i.e., the luminance data);
Step 410: Generate the second frame differences according to the data of the second color component (i.e., the chrominance data);
Step 415: Combine the first frame differences and the second frame differences to derive the candidate frame differences; and
Step 420: Perform film mode detection according to the candidate frame differences.
   Those skilled in the art will readily observe that numerous modifications and alterations of the device and method may be made while retaining the teachings of the invention.

What is claimed is:

1. A video processing method for determining a target motion vector, comprising:
generating a plurality of candidate temporal matching differences according to data of different color components in a specific color system; and
determining a vector associated with a minimum temporal matching difference from the candidate temporal matching differences as the target motion vector.

2. The video processing method of claim 1, wherein the data of the different color components comprise luminance (luma) data and chrominance (chroma) data.

3. The video processing method of claim 1, wherein the different color components comprise a first color component and a second color component, and the step of generating the candidate temporal matching differences comprises:
generating a plurality of first temporal matching differences according to data of the first color component;
generating a plurality of second temporal matching differences according to data of the second color component; and
respectively combining the first temporal matching differences and the second temporal matching differences to derive the candidate temporal matching differences.

4. The video processing method of claim 3, wherein the first color component is luminance (luma), and the second color component is chrominance.

5. A video processing method for determining a target motion vector, comprising:
generating a plurality of candidate temporal matching differences according to chrominance data; and
determining a vector associated with a minimum temporal matching difference from the candidate temporal matching differences as the target motion vector.

6. A film mode detection method, comprising:
generating a plurality of candidate frame differences from a plurality of received frames according to data of different color components in a specific color system; and
performing a film mode detection according to the candidate frame differences.

7. The film mode detection method of claim 6, wherein the data of the different color components comprise luminance (luma) data and chrominance (chroma) data.

8. The film mode detection method of claim 6, wherein the different color components comprise a first color component and a second color component, and the step of generating the candidate frame differences comprises:
generating a plurality of first frame differences according to data of the first color component;
generating a plurality of second frame differences according to data of the second color component; and
respectively combining the first frame differences and the second frame differences to derive the candidate frame differences.

9. The film mode detection method of claim 8, wherein the first color component is luminance (luma), and the second color component is chrominance.

10. A film mode detection method, comprising:
generating a plurality of candidate frame differences from a plurality of received frames according to chrominance data; and
performing a film mode detection according to the candidate frame differences.
